(19) United States
(12) Patent Application Publication
(10) Pub. No.: US 2011/0116372 A1
(43) Pub. Date: May 19, 2011

(54) NETWORK ACCESS CONTROL USING AN ADDITIONAL TRAFFIC CLASS IN A COMMUNICATION NETWORK

(75) Inventors: Joachim Charzinski, Munchen (DE); Thomas Engel, Unterbiberg (DE); Claus Gruber, Munchen (DE); Thomas Schwabe, Munchen (DE)

(73) Assignee: NOKIA SIEMENS NETWORKS GMBH & CO. KG, Munchen (DE)

(21) Appl. No.: 12/294,750

(22) PCT Filed: Mar. 21, 2007
(86) PCT No.: PCT/EP2007/052675

§ 371 Date: Nov. 3, 2010

(30) Foreign Application Priority Data
Mar. 30, 2006 (DE) 10 2006 015 239.5

(51) Int. Cl. H04L 12/26

(52) U.S. Cl. 370/232

(57) ABSTRACT

The aim of the invention is to provide a method, network control unit and a communication network for optimising the traffic in a communication network that is configured from network components, these entities permitting a degradation of service quality caused by the non-availability of network components to be at least temporarily averted. The solution to said aim is provided by a method for network access control in a communication network configured from network components, said method comprising the following steps: a) introduction of an additional traffic class to supplement a non-prioritising traffic class, more particularly a best effort class, and a traffic class offering a quality of service; b) configuration of a predeterminable bandwidth for the transmission of traffic in the additional traffic class; c) positioning of the additional traffic class above the non-prioritising traffic class and below or on the same level as the traffic class offering a quality of service; and d) authorisation of the use of the predeterminable bandwidth for the transmission of traffic in the additional traffic class for a predeterminable time period.

### CLAIM FOR PRIORITY

This application is a national stage application of PCT/EP2007/052675, filed Mar. 21, 2007, which claims the benefit of priority to German Application No. 10 2006 015 239.5, filed Mar. 30, 2006, the contents of which hereby incorporated by reference.

### TECHNICAL FIELD OF THE INVENTION

The invention relates to a method, a network control unit and a communication network for network access control in a communication network formed with network components.

### BACKGROUND OF THE INVENTION

One of the presently most important developments in the field of networks is the development of data networks for the transmission of real-time traffic such as language, video or audio data.

The most widespread and most used network technology in the field of data networks is based on the transmission of data packets by means of the so-called IP protocol (Internet Protocol). The most important case of application of this network technology is the so-called Internet, actually a network interconnection in which data can be exchanged virtually worldwide via interconnected networks which are also called autonomous systems. Conventionally, packet-oriented networks such as the Internet were provided for the transmission of data as part of a so-called “best effort”, i.e. for a data transmission without the guarantee of quality-of-service features. To expand packet-oriented networks with respect to the transmission of real-time traffic, mechanisms for guaranteeing quality-of-service features must be provided.

An important approach for guaranteeing quality-of-service features for transmission over packet-oriented networks is a strict control of the traffic flowing into the network and out of it again (the expression “policing” is also used). The access control is then frequently expanded also with other measures, for example for a rapid response to faults in order to be able to guarantee the quality of service.

A more recent approach for access controls in packet-oriented networks is described in the international patent application WO 2004/021947 and WO 2004/021648. In this approach, an entry node and an exit node are determined for traffic to be routed through a packet network and access controls are carried out with reference to these entry and exit nodes. This can be done, for example, in that the traffic which flows between the entry node and the exit node is limited (WO 2004/021647) or in that separate controls are carried out for the traffic entering at the entry node and the traffic emerging at the exit node (WO 2004/021648). Such access controls can ensure that overload situations are avoided within the network and, as a result, reliable information about the quality of service can be provided. In this manner, the individual networks or autonomous systems of a network interconnection can be expanded for a transmission maintaining quality-of-service features. For a transmission over a number of networks, it must be additionally guaranteed that the quality-of-service (QoS) features implemented within the networks are also guaranteed in the transmission between the individual networks. On the one hand, this relates to a limitation of traffic to avoid an overload and, on the other hand, to a redundancy for averting disturbances or failures, respectively.

One possibility of meeting these quality criteria in the transmission between networks is to provide two or more links between the various networks which represent mutual reserve links or back-up links and, at the same time, to dimension the traffic in such a manner that no overload occurs in normal operation and the various interference scenarios. Such a treatment of the links between various networks or inter-domain links is found to be difficult with respect to the coordination with the access control within the individual networks (or intra-domain access control, respectively) because both problems are coupled to one another. The determination of the parameters in the intra-domain access control would then have to take place as determined by the inter-domain situations.

In a packet-oriented communication network with bandwidth reservations for QoS traffic, there is also the basic problem of setting up the reservation again on a new path after a change of the transmission routes, for example due to a failure of a line. In the time between the failure and the setting-up of the new reservations, the quality of service for the QoS traffic is not guaranteed in spite of the routines explained above because the rerouted QoS traffic is conducted either as best-effort traffic without prioritization and must therefore share the available bandwidth with the other best-effort traffic or is still treated as QoS traffic but is discarded at the network edge because of the lack of reservation. In both cases, therefore, the quality of service can suffer considerably for reserved traffic flows.

### SUMMARY OF THE INVENTION

The present invention discloses a method, a network control unit and a communication network for network access control in a communication network configured from network components which at least temporarily avert a degradation of service quality caused by the non-availability of network components.

According to one embodiment of the invention, there is a method for network access control in a communication network formed with network components, which comprises:

a) introduction of an additional traffic class to supplement a non-prioritizing traffic class, more particularly a best-effort class, and a traffic class offering QoS;
b) configuration of a predeterminable bandwidth for the transmission of traffic in the additional traffic class;
c) positioning of the additional traffic class above the non-prioritizing traffic class and below or on the same level as the traffic class offering QoS; and
d) authorization of the use of the predeterminable bandwidth for the transmission of traffic in the additional traffic class for a predeterminable time period.

In this manner, for example, the “overflow” traffic occurring after the failure of a network component can be routed via a new path without losses of QoS for the duration of the predetermined time period until a new successful reservation is present. This allows an inter-domain error reaction for the QoS traffic to be distinctly accelerated because the bandwidth reservations must be repeated only after a rerouting. At the same time, the time limitation and the bandwidth limitation prevent a misuse of the access into this additional traffic class as a result of which the method cannot be corrupted.

In an another embodiment of the invention, the additional traffic class is provided for traffic which is diverted because of a network component which is unavailable due to an event. If thus, for example, a line fails, the traffic handled via the line is reclassified into the additional traffic class by default and transported with the above-mentioned boundary conditions. In this context, the additional traffic class can also be made accessible for the traffic without prior reservation as a result of which the scheduling and policing of this traffic can be arranged particularly efficiently.

In the event of the failure of a network component, QoS losses can be reliably prevented if the unmarked traffic is transported with new reservations via the remaining network. It is thus especially appropriate if the length of the predeterminable time period is designed in such a manner that a new bandwidth reservation can be carried out in the communication network which no longer contains the unavailable network component. To determine this time period, a mean time period can be assumed, for example, which is usually required for calculating the new admission control budgets and reservations.

So that a traffic flow in the additional traffic class with the limited bandwidth and the limited time period can be set up in the policing, the additional traffic class can be allocated a limited bandwidth in an advantageous development of the invention for the predeterminable time period by means of a dual leaky bucket policer, in that its high-bit-rate part is designed for a limitation of the bandwidth to a first bit rate with low burst tolerance and its low-bit-rate part is designed for a second bit rate with high burst tolerance, the first bit rate being large with respect to the second bit rate.

Apart from a suitable network dimensioning, it is advantageous if the admission control budgets are dimensioned in such a manner that the bandwidth needed for the transmission of the traffic in the additional traffic class is taken into consideration. As a result, the occasionally needed bandwidths for the traffic in the additional traffic class can be provided with sufficiently great probability as a result of which it is prevented at the same time that the QoS traffic can book out the entire bandwidth of the network with reservation.

In order to settle a currency account for the traffic transported in the additional traffic class also with neighboring operators, it is appropriate to register the traffic transported in the additional traffic class by volume.

In a further embodiment, the additional traffic class can be treated equally with the traffic class offering QoS instead of a prioritization of the additional traffic class between traffic classes offering QoS and non-prioritizing traffic classes (best-effort class), the traffic passed in the additional traffic class and the QoS traffic authorized in the communication network being designed for the maximum available transmission capacity. It is especially by adhering to this boundary condition that the dual leaky bucket budgets can be adjusted comparatively optimally for the maintenance of the quality of service.

In order to transmit the non-registered traffic with satisfactory bandwidth, it is provided to mark the traffic not registered at a network termination of the communication network in the additional traffic class. Similarly, as an alternative or also as a supplement for data packets with QoS marking arriving at a network edge which, however, do not have a reservation, a remarking into the additional traffic class can be carried out. This remarking can already be carried out in a preceding communication network if the data packets have been forwarded away from an originally planned route.

In still another embodiment of the invention, there is a network control unit having a device for carrying out the method according to the invention. Such a network control unit can be given, e.g. by:
An apparatus for traffic limiting/access control or admission control unit, e.g. an add-on computer which is placed next to a router or a remote resource management unit, a so-called bandwidth broker or a software component in a router which operates in accordance with the method according to the invention.
A network management unit or a network control server which calculates, and/or configures in the abovementioned units, the limit values for the access control (so-called admission control budgets).
A network planning tool which uses the method according to the invention in the determination of the necessary link capacities for a given traffic or the permissible traffic in a network.
A unit (e.g. in the network management or at an other place) which performs the marking/remarking of the diverted traffic into the additional traffic class and for the transport of which the granted bandwidth is allowed for the predetermined time period.

In addition, the invention comprises a communication network having means for carrying out a method according to the invention. Such a communication network can comprise, in particular, a network control unit having means for carrying out a method according to the invention.

### BRIEF DESCRIPTION OF THE INVENTION

Exemplary embodiments of the invention will be explained in greater detail with reference to a drawing, in which:

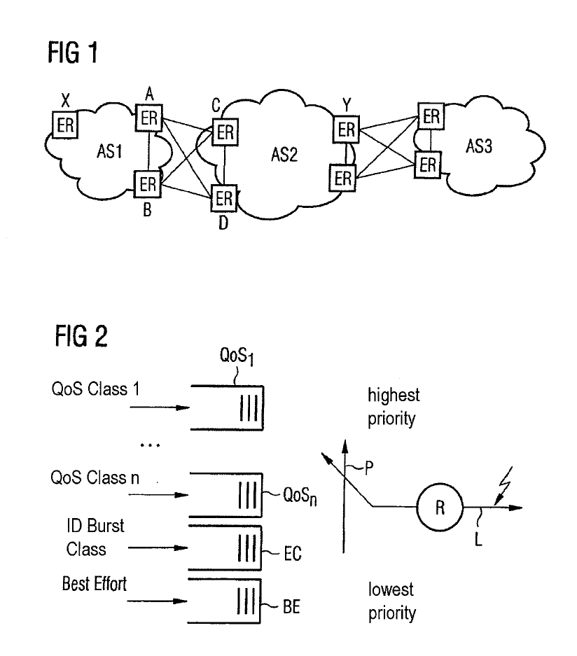

FIG. 1 shows a communication network.

FIG. 2 shows the prioritization of traffic classes in scheduling.

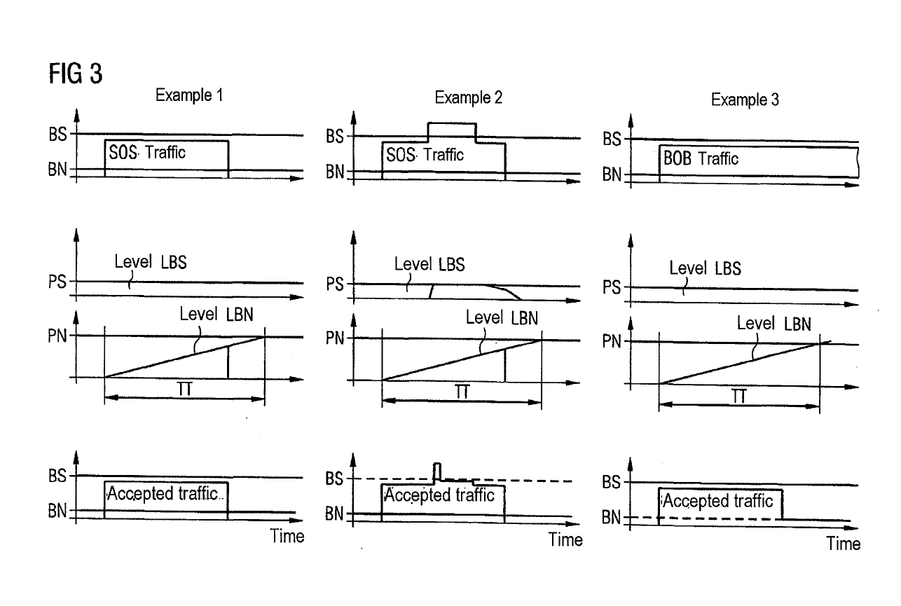

FIG. 3 shows the configuration of a dual leaky bucket policer.

### DETAILED DESCRIPTION OF THE INVENTION

FIG. 1 shows three networks or autonomous systems AS1, AS2 and AS3. Traffic can enter and exit these networks through edge nodes. By way of example, some edge nodes designated by ER (Egress Router) are drawn in the figures. Fault tolerance is typically provided for the transmission between two autonomous systems, e.g. AS1 and AS2 by using in each case two edge nodes of the networks and each of these four nodes is connected with each one, e.g. A, B, C and D. If then, e.g., traffic is to be transmitted from the edge nodes or edge point X via the autonomous system AS1 and the autonomous system AS2 to the edge point Y and from there into the autonomous system AS3, the edge points A, B, C and D provide a fault-tolerant networking of the inter-domain transition from the autonomous system AS1 to the autonomous system AS2. If, e.g., the link between A and C fails, the traffic which has been conducted directly from A to C can now be conducted to C indirectly via B or D. However, this conventional approach entails the problem that in the reliability restrictions or policing relating to the network, any faults should also be taken into consideration. This means that, e.g. in the case of a failure of the link between A and C, the traffic diverted via B does not lead to an overload at point B. This problem is difficult in the case of networks which operate with checking the reliability which will relate to edge nodes or edge points, e.g. X and A and X and B, respectively, but can now be handled in a comparatively simple manner in accordance with the present invention.

In this respect, FIG. 2 shows in a diagrammatic representation an exemplary prioritization of traffic classes with quality-of-service reservation QoS₁ to QoSₙ, an additional ID burst class EC arranged below this and the least-prioritized best-effort class BE. With regard to the reservation of bandwidths for the transmission, the prioritization increases from bottom to top in accordance with an arrow P in the representation shown, i.e. the traffic marked with traffic class QoS₁ enjoys the highest quality of service; correspondingly, the traffic marked with traffic class BE can now only be provided with a minimum of bandwidth if traffic for transmission by means of a router R is present in the more highly prioritized traffic class. In traffic class EC, the traffic which, for example, had been handled currently via a link L which spontaneously failed can now be absorbed. The bandwidth reserved for this is abruptly lost with the failure of link L and, without the precautions according to the invention, would normally lead to a loss of the data packets due to the termination of the link. According to the scheduling explained above, a policy now becomes effective in which the interrupted traffic is remarked, for example, from one of the QoS classes into the ID burst class EC and is now transmitted with an assured bandwidth BS for a maximum time period TT.

In this respect, FIG. 3 shows in a diagrammatic form the configuration of a dual leaky bucket policer. The allowed boundary condition consists in that a stream of packets in the ID burst class EC can only use the limited bandwidth BS and this also only for a predetermined time period TT (tolerance time). In this context, the predetermined time period TT is designed in such a manner that it is possible during this time period TT also referred to as the tolerance time to carry out a new bandwidth reservation in the affected network AS1, AS2 or AS3. This provides, particularly in the case of an inter-domain transition, for an access to this ID burst class even for traffic coming from other networks without previous reservation.

In the text which follows, this procedure will be explained with three examples 1 to 3. A dual leaky bucket policer is implemented, the high-bit-rate part LBS of which is designed for a limitation of the bandwidth to BS with a relatively low burst tolerance PS and the low-bit-rate part LBN of which is designed for a very low bit rate BN<<BS with relatively large burst tolerance so that the transmission in the ID burst class EC is made possible with the bandwidth BS during the time period TT. In this context, the dual leaky bucket policer is understood to be a virtual queue which is correspondingly filled with each incoming packet and emptied again with the bit rate BS, BN configured for the policer. When the virtual queue is filled up to the limit (bucket size), the packets which are still arriving are discarded.

In example 1, the top figure shows an “SOS traffic” located in the ID burst class, the bit rate of which is between the limited bit rate BS and the very low bit rate BN and the time period of which is shorter than the predetermined time period TT. The level of the high-bit-rate part LBS therefore remains below the relatively low burst tolerance PS. The level of the low-bit-rate part LBN rises linearly and drops again with the decay of the SOS traffic. The bottom figure shows that the accepted traffic actually transmitted exactly corresponds to the SOS traffic.

In example 2, the bit rate of the SOS traffic now temporarily exceeds the bit rate BS. However, the entire time period of the SOS traffic is still smaller than the predefined time period TT. For the level of the high-bit-rate part LBS, this means a steep rise up to the burst tolerance PS at which the curve remains until the SOS traffic decays below the bit rate BS and only drops again with the selected bit rate after that. The low-bit-rate part LBN fills up again linearly and drops off when the SOS traffic drops off. The accepted traffic now shows a course which required explanation but is logical. When the bit rate BS of the SOS traffic is exceeded, the latter is still transmitted until the burst tolerance PS is reached at the level of the LBS. The bit rate is then reset to BS and a part of the SOS traffic is lost here. When it falls below the burst tolerance PS, the SOS traffic is also transmitted again 1:1.

Example 3 is then linked again with the first example, only in that the SOS traffic would like to claim a longer time period than the time period TT. During the time period TT, the SOS traffic is transmitted with the same content as accepted traffic. When the time period TT, also called tolerance time, expires, the accepted traffic is also lowered from the high bit rate BS to the low bit rate BN, however. However, if it were possible to calculate new reservations without the failed link during the time period TT, the traffic still marked here as SOS traffic in the ID burst class could be handled again, for example, as regular QoS traffic in one of the QoS classes QoS₁ to QoSₙ.

As is shown in the examples 1 to 3 of FIG. 3, the traffic occurring after an inter-domain failure, which is to be diverted, can thus be transmitted in the newly created ID burst class EC without losses of the QoS for the time period TT until a successful new reservation policy becomes effective. The inter-domain error response for the QoS traffic is thus distinctly accelerated because the new bandwidth reservation only occurs after the rerouting. At the same time, the time restriction of the utilization period and the bandwidth limitation of the ID burst class EC create a tried and tested means for keeping the traffic in this class within justifiable and non-malicious limits.

1. A method for network access control in a communication network formed with network components, comprising:
introducing an additional traffic class to supplement a non-prioritizing traffic class and a traffic class offering a QoS;
configuring a predeterminable bandwidth for the transmission of traffic in the additional traffic class;
positioning the additional traffic class above the non-prioritizing traffic class and below or on a same level as the traffic class offering a QoS; and
authorizing use of the predeterminable bandwidth for the transmission of traffic in the additional traffic class for a predeterminable time period.

2. The method as claimed in claim 1, wherein the additional traffic class is provided for traffic which is diverted because of a network component which is unavailable due to an event.

3. The method as claimed in claim 2, wherein the additional traffic class is made accessible for the traffic without prior reservation.

4. The method as claimed in claim 1, wherein a length of the predeterminable time period is designed such that a new bandwidth reservation performed in the communication network which no longer includes the unavailable network component.

5. The method as claimed in claim 1, wherein the additional traffic class is allocated a limited bandwidth for the predeterminable time period by a dual leaky bucket policer, such that its high-bit-rate part is designed for a limitation of the bandwidth to a first bit rate with low burst tolerance and its low-bit-rate part is designed for a second bit rate with high burst tolerance, the first bit rate being large with respect to the second bit rate.

6. The method as claimed in claim 1, wherein admission control budgets are dimensioned which take into consideration the bandwidth needed for the transmission of the traffic in the additional traffic class.

7. The method as claimed in claim 1, wherein the traffic transported in the additional traffic class is registered by volume.

8. The method as claimed in claim 1, wherein the additional traffic class is treated equally with the traffic class offering QoS, the traffic passed in the additional traffic class and the QoS traffic authorized in the communication network being designed for the maximum available transmission capacity.

9. The method as claimed in claim 1, wherein the traffic not registered at a network termination of the communication network is marked in the additional traffic class.

10. The method as claimed in claim 1, further comprising performing remarking into the additional traffic class for data packets with QoS marking arriving at a network edge which, do not have a reservation.

11. The method as claimed in claim 10, wherein the remarking is performed in a preceding communication network if the data packets have been forwarded away from an originally planned route.

12. A network control unit, comprising a device to control network access in a communication network formed with network components, comprising:
introducing an additional traffic class to supplement a non-prioritizing traffic class and a traffic class offering a QoS;
configuring a predeterminable bandwidth for the transmission of traffic in the additional traffic class;
positioning the additional traffic class above the non-prioritizing traffic class and below or on a same level as the traffic class offering a QoS; and
authorizing use of the predeterminable bandwidth for the transmission of traffic in the additional traffic class for a predeterminable time period.

13. A communication network, comprising a device to control network access control therein and formed with network components, comprising:
introducing an additional traffic class to supplement a non-prioritizing traffic class and a traffic class offering a QoS;
configuring a predeterminable bandwidth for the transmission of traffic in the additional traffic class;
positioning the additional traffic class above the non-prioritizing traffic class and below or on a same level as the traffic class offering a QoS; and
authorizing use of the predeterminable bandwidth for the transmission of traffic in the additional traffic class for a predeterminable time period.
